(19) United States
(12) Patent Application Publication
(10) Pub. No.: US 2024/0289623 A1
(43) Pub. Date: Aug. 29, 2024

(54) EDITING A TARGET MODEL TO FORGET DATA SAMPLES USING A REFERENCE MODEL TO ADJUST WEIGHTS OF THE TARGET MODEL

(71) Applicant: INTERNATIONAL BUSINESS MACHINES CORPORATION, Armonk, NY (US)

(72) Inventors: Ron SHMELKIN, Givatayim (IL); Abigail GOLDSTEEN, Haifa (IL); Ariel FARKASH, Shimshit (IL); Tal ZOHAR, Haifa (IL)

(21) Appl. No.: 18/176,068

(22) Filed: Feb. 28, 2023

(51) Int. Cl. G06N 3/084

(52) U.S. Cl. CPC G06N 3/084

(57) ABSTRACT

Provided are a computer program product, system, and method for editing a target model to forget data samples. Forget data samples of data samples to forget are inputted into a reference model, trained on a non-private data set, to produce reference output. The forget data samples to forget are inputted to a target model, trained on a total data set comprising the non-private data set and a private data set, to produce target output. The private data set includes the forget data samples A loss function is calculated to measure a divergence of the reference output and the target output. A determination is made of gradients that minimize an error of the loss function. Optimized gradients are calculated from the determined gradients. The optimized gradients are applied to update weights in the target model to produce an edited target model.

### BACKGROUND OF THE INVENTION

### 1. Field of the Invention

The present invention relates to a computer program product, system, and method for editing a target model to forget data samples using a reference model to adjust weights of the target model.

### 2. Description of the Related Art

Modern data regulatory frameworks, such as the European General Data Protection Regulation (GDPR) and California Consumer Privacy Act (CCPA), as well as additional data protection regulations in other countries, grant data subjects the right to withdraw their consent to the use and processing of their personal data, as well as request the deletion of their data from organizations' data stores. These regulations are known as “the right to be forgotten”. Membership and attribute inference attacks have shown that personal information is present in and can indeed be extracted from machine learning models trained on data sets including user personal information. This has led some experts to the conclusion that machine learning models themselves can be considered personal information, and therefore subject to data privacy and data opt-out laws. Upon a data removal request, current systems process the machine learning model with an unlearning algorithm to forget the data to forget incorporated inside the model. Unlearning algorithms operate by obtaining a model that is as similar as possible to another model trained without using the forget data.

There is a need in the art to provide improved techniques for training a machine learning model to forget data samples.

### SUMMARY

Provided are a computer program product, system, and method for editing a target model to forget data samples. Forget data samples of data samples to forget are inputted into a reference model, trained on a non-private data set, to produce reference output. The forget data samples to forget are inputted to a target model, trained on a total data set comprising the non-private data set and a private data set, to produce target output. The private data set includes the forget data samples A loss function is calculated to measure a divergence of the reference output and the target output. A determination is made of gradients that minimize an error of the loss function. Optimized gradients are calculated from the determined gradients. The optimized gradients are applied to update weights in the target model to produce an edited target model.

### BRIEF DESCRIPTION OF THE DRAWINGS

FIG. 1 illustrates an embodiment of an untraining system to train a target model to forget data samples.

FIG. 2 illustrates an embodiment of a flow of operations to train an edit model used to optimize the gradients used to adjust the target model to remove the impact of the forget data samples.

FIG. 3 illustrates an embodiment of operations to edit a target model to remove the effect of data samples to forget.

FIG. 4 illustrates an embodiment of operations to train an edit model used to optimize gradients used to modify the target model.

FIG. 5 illustrates a computing environment in which the components of FIGS. 1 and 2 may be implemented.

### DETAILED DESCRIPTION

Described embodiments provide improved computer technology for training a machine learning model, referred to as the target model, to unlearn or forget a data set, such as a data set that a user has requested to remove from a computing platform, including the target model. Described embodiments provide a process to remove the effect of forget data, or data samples to forget, from the target model, by comparing a difference or error of output from the target model, trained on a total data set comprised of non-private data and private data, and output from a reference model trained on a non-private data set. The target model is trained to have an output probability distribution for the forget data similar to the probability distribution of the reference model, trained on only non-private data. The weights of the target model are adjusted in an edited target model to have a probability distribution similar to the reference model for the data to forget.

Described embodiments provide an additional optimization to train an edit model to further optimize the gradients, generated from comparing the output from the target model and the reference model. The edit model is trained to receive as input gradients for the target model to approximate the probability distribution of the reference model and output optimized gradients that would modify the edited target model to have a probability distribution approximating that of the target model probability distribution for input comprising a remainder data set comprising the total data set with the forget data samples removed. In this way, the gradients are further optimized to improve the accuracy of the edited target model when operating on the remainder data set to have the accuracy of the target model which is trained on the largest data set, the total data set.

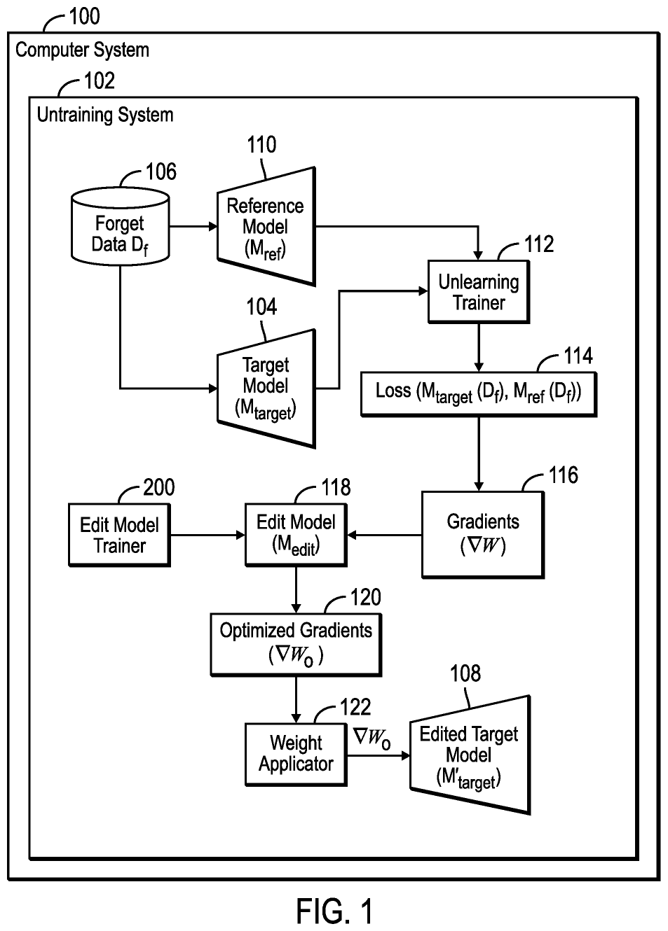

FIG. 1 illustrates an embodiment of a computer system 100 including components comprising an untraining machine learning model system 102 to untrain a target machine learning model (M_{target}) 104, also referred to as a target model 104, to remove the effect of the forget data 106, comprising data samples that need to be removed, from the weights at the neural network nodes of the target model 104. The target model is trained on a total data set D comprising a non-private available data set (D_{pub}), such as a publicly available data set, and a private data set (Dₚᵣᵢᵥₐₜₑ), including but not limited to an anonymized data set and/or synthetic data set. From time to time, the untraining system 102 may have to edit the target model 104 to remove data samples to forget. A person that previously supplied, under agreement, their data to be part of the private data set may request that their personal data be removed. Upon receiving the request to remove data samples, referred to as forget data D_{f} 106, the target model 104 will have to be untrained to remove the effect of that forget data 106 embedded in the weights in the layers of the neural network of the target model 104. To adjust the weights of the target model 104, an unlearning trainer determines gradients for the target model 104 that are input to an edit model 118 to output optimized gradients 216 applied to the target model 104 to produce an edited target machine learning model (M_{target}) 108, also referred to as an edited target model 108. The edited target model 108 has the same neural network architecture of nodes and layers as the target model 104.

During the untraining process, the target model 104 remains unchanged, comprising the machine learning model trained on the total data set D, and changes to the weights/gradients are applied to the edited target model 108 to produce the target model 104 untrained on the forget data 106. A reference machine learning model (M_{ref}) 110, also referred to as reference model 110, comprises the same neural network architecture, i.e., nodes and layers, of the target model 104 that is trained on the non-private data set (D_{pub}). An unlearning trainer 112 seeks to accomplish the simultaneous goals when untraining the target model 104 to forget the forget data 106 but maintain the accuracy of the target model 104, which is trained on the total data set (D), when the target model 104 would operate on a remaining data set (Dᵣ) comprising the total data set (D) without the forget data 106.

In order to forget the forget data 106, the edited target model 108 is edited to produce output from input comprising the forget data 106 that has a probability distribution similar to the reference model 110, which is trained on only non-private data. At the same time, in order to preserve the accuracy of the target model 104, trained on the total data set (D), the edited target model 108 output probability distribution should not change significantly from the target model 104 when operating on the remaining data set (Dᵣ) not including the forget data 106.

The unlearning trainer 112 inputs the forget data 106 into both the reference model 110 and the target model 104. The unlearning trainer 112 then forms a loss function 114 between reference output from the reference model, M_{ref}(D_{f}), which is considered the ground truth of output without the forget data 106, and the target output from the target model 104, M_{target} (D_{f}). In one embodiment, the loss function 114 may comprise a Kullback-Leibler (KL) divergence loss that measures the distance or relative entropy between the probability distributions outputted by the reference model 110 of M_{ref} (D_{f}) and outputted by the target model 104 of M_{target} (D_{f}). Other divergence methods may be used to model the loss, including cross entropy techniques, Jensen-Shannon divergence, mean squared error, etc.

The unlearning trainer 112 may then calculate partial derivatives of the loss function for the weights of the target model 104 to determine gradients (∇W) 116 to adjust the weights of the target model 104 to minimize the loss function 114. The gradients 116 are inputted into an edit machine learning model (Meat) 200, also referred to as the edit model 200, to produce optimized gradients (∇W′) 120. A weight applicator 122, which may be part of the unlearning trainer 112, applies the optimized gradients 120 to the edited target model 108. The optimized gradients 120 modify the edited target model 108 so that that the output probability of the edited target model 108 does not change significantly from the target model 104 for input comprising the remainder data set without the forget data samples 106.

The edit model trainer 200 trains the edit model 118 to modify the gradients 116, optimized to modify the target model 104, to approximate the probability distribution of the reference model 110, trained on non-private data, when applied to the forget data 106 and to approximate the probability distribution of the target model 104 when applied to the remainder data.

The edit model 118 may comprise a Model Editor Network using Gradient Decomposition (MEND), which comprises an auxiliary of editing networks using a single desired input-output pair to make fast, local edits to a pre-trained model's behavior.

With the embodiment of FIG. 1, the edited target model 108 is edited in one shot with the optimized gradients 120 without any training to forget specific samples.

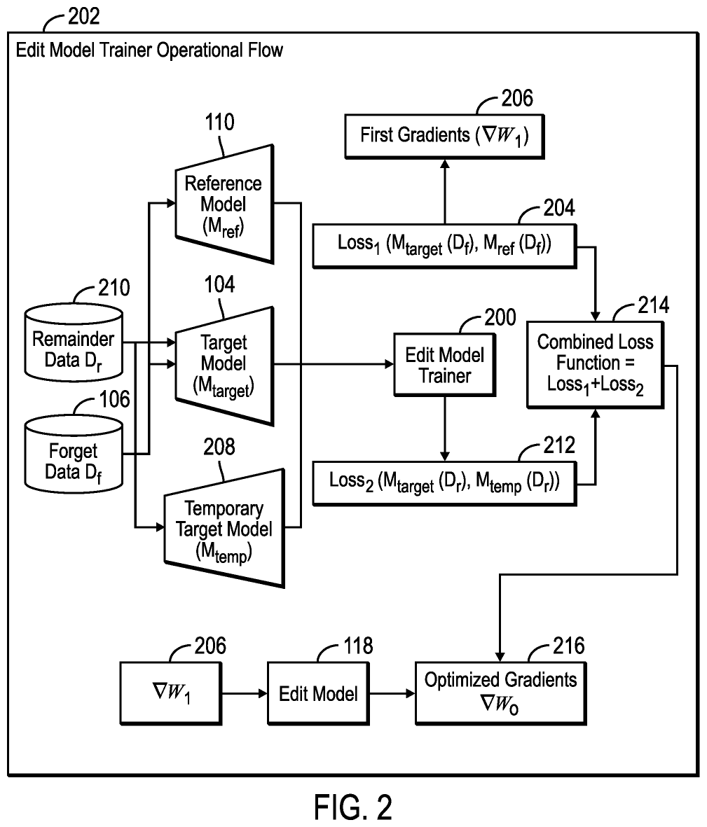

FIG. 2 illustrates an embodiment of an operational flow 202 of the edit model trainer 200 to train the edit model 118 to modify the gradients 116 from the loss function 114 to produce optimized gradients 120 that are applied to the target model 104 to yield the edited target model 108. In this way, the output on the remaining data set (Dᵣ) from the edited target model 108 is close to the probability distribution on the target model 104. The edit model trainer 200 inputs the forget data 106 into the reference model 110 and the target model 104 to produce output and forms a first loss function 204, loss₁, that defines an error function between the ground truth output M_{ref}(D_{f}) of the reference model 110 and the output M_{target} (Df) of the target model 104. The edit model trainer 200 solves partial derivatives of the first loss function 204 to minimize the error and determine first loss gradients 206 that modify the target model 104 to converge toward the reference model 110 to forget the forget data 106. The first loss gradients 206 are applied to the target model 104 to yield a temporary target model 208. The temporary target model 208 is a temporary edited model that is used for the training iteration of the edit model 118 and then discarded.

The edit model trainer 200 inputs remainder data 210, which does not include the forget data 106, into the target model 104 and the temporary target model 208 to produce output and forms a second loss function 212, loss₂, that defines an error function between the ground truth target model 104 M_{target} (Dᵣ), trained on the total data set, and the temporary target model Mₜₑₘₚ (Dᵣ). The first loss function 204 and the second loss function 212 are combined to form a combined loss function 214. The edit model trainer 200 performs partial derivatives of the combined loss function 214 to minimize the error and determine optimized gradients (∇W_{O}) 216. The edit model trainer 200 will then train the edit model 118 to produce the optimized gradients 216 from input comprising the first loss gradients 206. The trained edit model 118 may then be deployed to adjust the weights to provide the optimized gradients 120, 216 to yield an edited target model 108 that will stay close to the probability distribution of the target model 104 for the remainder data set 210.

In certain embodiments, after training the edited target model 108 to have weights not based on the forget data sample 106 and upon receiving a new forget data sample to remove, the edited target model 108 becomes the new initial state (i.e., the new target model) and it can have its weights adjusted again in the same manner to have unlearned all previous forget data samples 106.

The arrows shown in FIGS. 1 and 2 between the components and objects in the untraining system 102 and the edit model trainer operational flow 202 represent a data flow between the components.

In certain embodiments, many of the described components, such as the machine learning models 104, 108, 110, 118 may use gradient-based models such as neural network and deep learning algorithms and architectures, such deep neural networks (DNN), recurrent neural networks (RNN), Feedforward neural networks, Convolutional Neural Networks (CNN), etc. For artificial neural network program implementations, the neural network may be trained using backward propagation to adjust weights and biases at nodes in a hidden layer. Backward propagation used to train a neural network machine learning module computes the gradient of the loss function with respect to the weights of the network, iterating backward from the last layer, using the chain rule.

Backward propagation may be used with an algorithm for supervised learning of artificial neural networks using gradient descent. Given an artificial neural network and an error function, the method may use gradient descent to find the weights or coefficients, for the nodes in a neural network or function that minimizes a cost function measuring the difference or error between actual and predicted values for different weights. The parameters are continually adjusted during gradient descent to minimize the error.

Generally, program modules, such as the program components 104, 108, 110, 112, 118, 122, 200, 212 may comprise routines, programs, objects, components, logic, data structures, and so on that perform particular tasks or implement particular abstract data types. The program components and hardware devices of the computer systems 100 in FIGS. 1 and 2 may be implemented in one or more computer systems, where if they are implemented in multiple computer systems, then the computer systems may communicate over a network.

The program components in FIGS. 1 and 2, including components 104, 108, 110, 112, 118, 122, 200, 212, may be accessed by a processor from memory to execute. Alternatively, some or all of the program components in FIGS. 1 and 2, including components 104, 108, 110, 112, 118, 122, 200, 212, may be implemented in separate hardware devices, such as one or more Application Specific Integrated Circuit (ASIC) hardware devices.

The functions described as performed by the program components of FIGS. 1 and 2, including components 104, 108, 110, 112, 118, 122, 200, 212, may be implemented as program code in fewer program modules than shown or implemented as program code throughout a greater number of program modules than shown.

The computer system may comprise a personal computing device, such as a laptop, desktop computer, tablet, smartphone, wearable computer, server class computing devices, or other suitable computing devices.

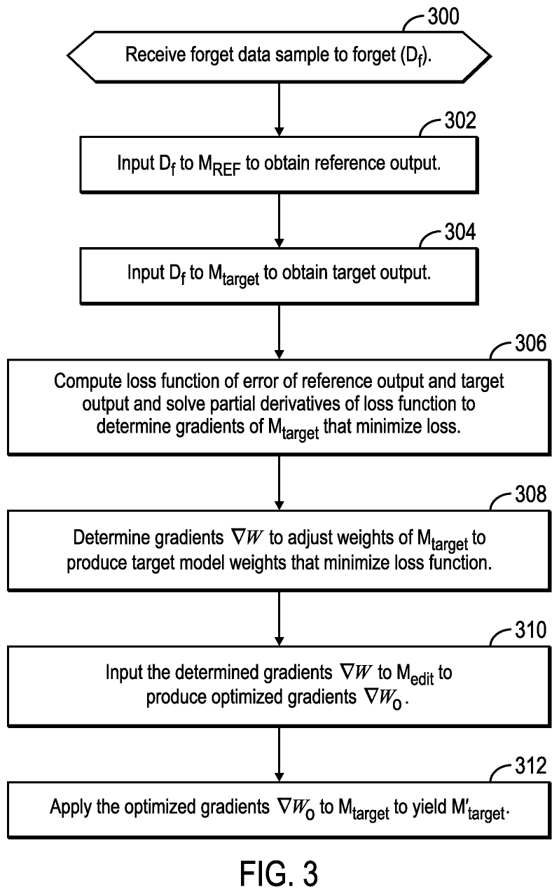

FIG. 3 illustrates an embodiment of operations performed by the unlearning trainer 112 and weight applicator 122 in the untraining system 102 to produce an edited target model 108 whose weights are not based on forget data 106 and that have a similar accuracy as the target model 104, trained on the remainder data. Upon receiving (at block 300) a forget data sample 106 to forget, the unlearning trainer 112 inputs (at block 302) the forget data sample 106 to the reference model 110 to obtain reference output M_{ref}(D_{f}). The unlearning trainer 112 inputs (at block 304) the forget data sample 106 to the target model 104 to obtain target output M_{target}(D_{f}). The unlearning trainer 112 computes (at block 306) a loss function 204, e.g., Loss (M_{target} (D_{f}), M_{ref} (D_{f})), of the error of the reference output M_{ref}(D_{f}) and target output M_{target}(D_{f}), and solves partial derivatives of the loss function 204 to determine gradients of the target model 104 that minimizes the loss. In one embodiment, the loss function 204 may comprise a KL divergence function, such as equation (1) below:

KLDiv(M_{target}(D_{f}),M_{ref}(D_{f})) (1)

The unlearning trainer 112 determines (at block 308) gradients ∇W 116 to adjust the weights of the target model 104 to produce target model weights that minimize the loss function 204. The gradients 116 are inputted (at block 310) to the edit model 118 to produce optimized gradients ∇W_{O} 116 that are optimized to mimic the probability distribution of the output of the edited target model 108 on the remainder data (Dᵣ). The weight applicator 122 applies (at block 312) the optimized gradients ∇W_{O} 120 to the target model 104 to remove the effects of the forget data 106 from the weights of the target model 104 to yield the edited target model M′_{target} 108. The edited target model M′_{target} 108 may be deployed to users as compliant with data privacy requirements that require removal of private data for users that request the removal of their personal and private data.

With the embodiment of FIG. 3, also known as a forgetting phase, the output distribution of the target model 104 is modified to approximate the distribution of the reference mode 110 when operating on the forget data 106. Further, in addition to the unlearning trainer 112, training the weights of the target model 104 to forget the forget data samples 106, the edit model 118 further adjusts the gradients to be applied to the target model 104 to maintain closeness to the distribution of the target model 104 with respect to the remainder data (Dᵣ) that excludes the forget data 106.

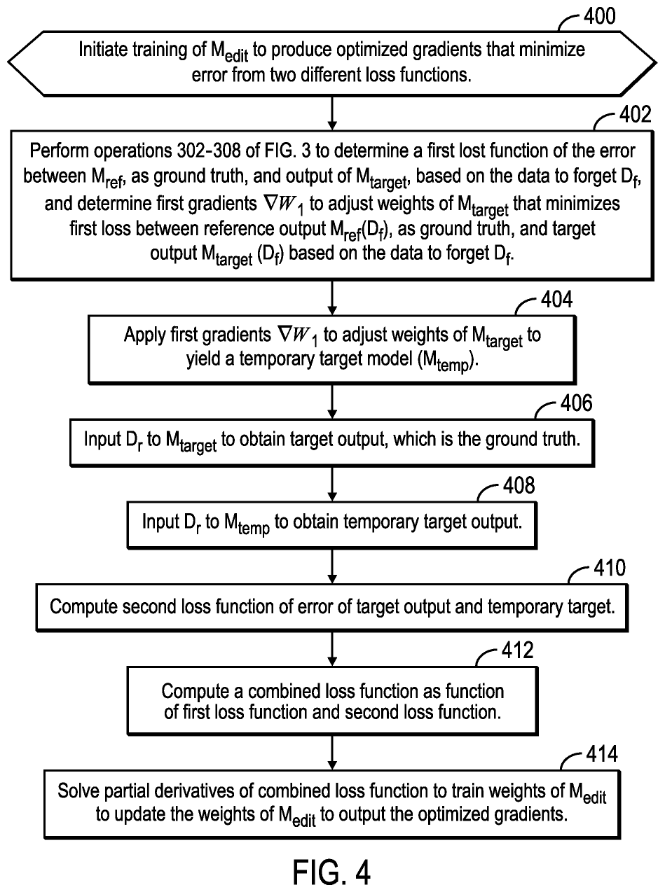

FIG. 4 illustrates an embodiment of operations performed by the edit model trainer 200 to train the edit model 118 to minimize error from two different loss functions, a first loss function 204 to forget the forget data 106, or approximate probability distribution of reference model 110 with respect to the forget data 106, and a second loss function 212 to approximate the distribution of the target model 104 on the remainder data 203 without the forget data 106. Upon initiating (at block 400) the operations to train the edit model 118, the edit model trainer 200 performs (at block 402) the operations 302-308 of FIG. 3 to determine first gradients ∇W1 206 to adjust weights of the target model 104 to minimize first the loss 204 between probability distribution of reference model 110 and the target model 104 based on the data to forget data 106. The first loss function 204 may utilize a KL divergence function and be defined as KLDiv(M_{target}(D_{f}), M_{ref} (D_{f})).

The edit model trainer 200 further applies (at block 404) first gradients ∇W₁ to adjust weights of the target model 104 to yield a temporary target model 208. The remainder data (Dᵣ) 210 is inputted (at block 406) to the target model 104 to obtain target output M_{target}(Dᵣ), which is the ground truth for a probability distribution of an accurate model for the remainder data set 210. The remainder data (Dᵣ) 210 is also inputted (at block 408) to obtain temporary target output Mₜₑₘₚ(Dᵣ). A second loss function 212 is computed (at block 410) as an error of target output M_{target}(Dᵣ) and the temporary target output Mₜₑₘₚ(Dᵣ). The second loss function 212 may utilize a KL divergence function and be defined as KLDiv(M_{target}(Dᵣ), Mₜₑₘₚ(Dᵣ).

The edit model trainer 200 computes (at block 412) a combined loss function 214 as a combination of the first loss function 204 and the second loss function 212. Equation (2) below provides an embodiment of the combined loss function 214:

λ₁*KLDiv(M_{target}(D_{f}),M_{ref}(D_{f}))+λ₂*KLDiv(Mₜₑₘₚ(Dᵣ),M_{target}(Dᵣ)) (2),

wherein λ₁ and λ₂ are weightings for the elements of the combined loss function 214. The edit model trainer 200 solves (at block 414) partial derivatives of the combined loss function 214 to train weights of the edit model 118 to update the weights of the edit model 118 to produce the optimized gradients (∇W_{O}) 216. The edit model trainer 200 uses (at block 416) backpropagation to update the weights of the edit model 118 to output the optimized gradients 200.

The operations of FIG. 4 may be performed multiple times until convergence is achieved.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

Computing environment 500 contains an example of an environment for the execution of at least some of the computer code involved in performing the inventive methods, including determining gradients for a target model to produce an edit target model and retraining an edit model that optimizes the determined gradient from to provide optimized gradients to use to modify the weights of the target model to produce the edited target model.

The computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 501, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

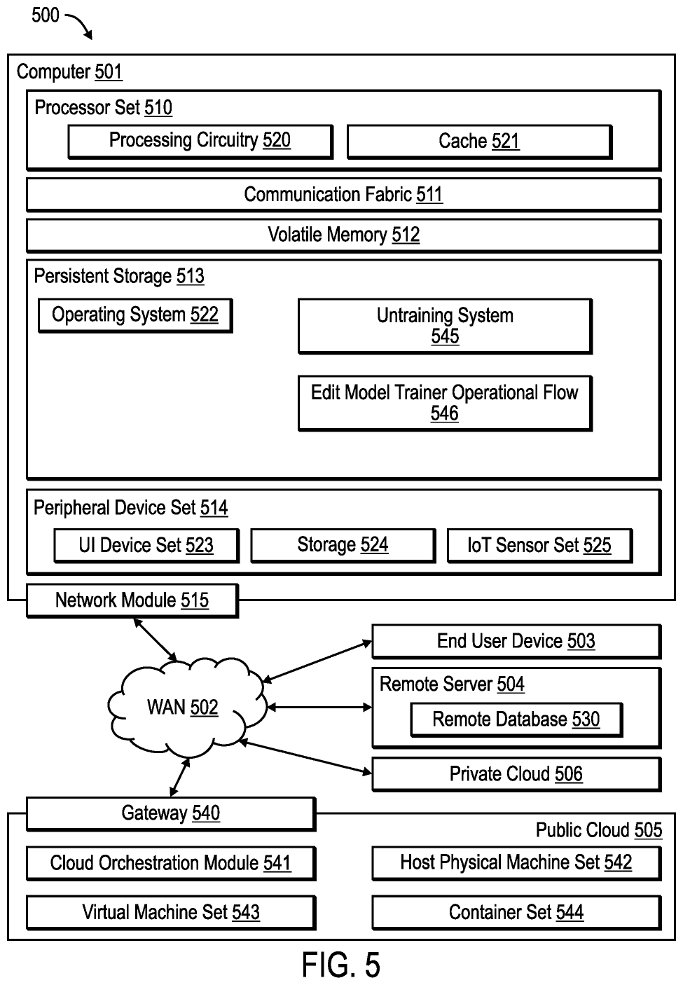

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in untraining system 545 and edit model trainer operational flow 546 typically includes at least some of the computer code involved in performing the inventive methods, including, but not limited to, the components in the computer system 100 comprising program components 104, 108, 110, 112, 118, 120, 122, 200, 212 in FIGS. 1 and 2.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on. In certain embodiments, the edited target model 108 may be provided to end user devices 503 to deploy to generate output from the inputs.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for editing a machine learning model to forget data, the computer program product comprising a computer readable storage medium having computer readable program code embodied therein that is executable to perform operations, the operations comprising:
inputting forget data samples of data samples to forget into a reference model, trained on a non-private data set, to produce reference output;
inputting the forget data samples to a target model, trained on a total data set comprising the non-private data set and a private data set to produce target output, wherein the private data set includes the forget data samples;
calculating a loss function to measure a divergence of the reference output and the target output; and
determining gradients that minimize an error of the loss function;
calculating optimized gradients from the determined gradients; and
applying the optimized gradients to update weights in the target model to produce an edited target model.

2. The computer program product of claim 1, wherein the calculating the optimized gradients comprises:
inputting the gradients into an edit model to produce optimized gradients.

3. The computer program product of claim 2, wherein the operations further comprise:
training the edit model to output the optimized gradients.

4. The computer program product of claim 3, wherein the edit model is trained to minimize an error of a combination of a first loss function and a second loss function, wherein the first loss function measures a divergence of the reference output and the target output.

5. The computer program product of claim 4, wherein the operations further comprise:
applying a first weight to the first loss function to calculate a weighted first loss function; and
applying a second weight to the second loss function to calculate a weighted second loss function, wherein the combination of the first loss function and the second loss function comprises a sum of the weighted first loss function and the weighted second loss function, wherein the producing the optimized gradients comprises solving partial derivatives of the combination of the first loss function and the second loss function to determine the optimized gradients.

6. The computer program product of claim 3, wherein the optimized gradients minimize an error of a combination of a first loss function and a second loss function, wherein the first loss function measures a divergence of the reference output and the target output, wherein the operations further comprise:
determining interim gradients that minimize an error of the first loss function, wherein the edit model is trained to output the optimized gradients from input comprising the interim gradients.

7. The computer program product of claim 6, wherein the reference output and the target output in the first loss function result from input comprising the forget data samples.

8. The computer program product of claim 3, wherein the optimized gradients minimize an error of a combination of a first loss function and a second loss function, wherein the first loss function measures a divergence of the reference output and the target output, wherein the operations further comprise:
determining interim gradients that minimize an error of the first loss function; and
applying the interim gradients to weights in the target model to yield a temporary target model, wherein the second loss function measures a divergence of the target model and the temporary target model.

9. The computer program product of claim 8, wherein the calculating the second loss function comprises:
forming a remainder data set comprising the total data set excluding the forget data set removed;
inputting the remainder data set to the target model to produce target output; and
inputting the remainder data set to the temporary target model to produce temporary target output, wherein the divergence of the target model and the temporary target model comprises a divergence of the target output and the temporary target output.

10. A system for editing a machine learning model to forget data, comprising:
at least one processor; and
a computer readable storage medium having computer readable program code embodied therein that when executed by the at least one processor performs operations, the operations comprising:
inputting forget data samples of data samples to forget into a reference model, trained on a non-private data set, to produce reference output;
inputting the forget data samples to a target model, trained on a total data set comprising the non-private data set and a private data set to produce target output, wherein the private data set includes the forget data samples;
calculating a loss function to measure a divergence of the reference output and the target output; and
determining gradients that minimize an error of the loss function;
calculating optimized gradients from the determined gradients; and
applying the optimized gradients to update weights in the target model to produce an edited target model.

11. The system of claim 10, wherein the calculating the optimized gradients comprises:
inputting the gradients into an edit model to produce optimized gradients.

12. The system of claim 11, wherein the operations further comprise:
training the edit model to output the optimized gradients.

13. The system of claim 12, wherein the edit model is trained to minimize an error of a combination of a first loss function and a second loss function, wherein the first loss function measures a divergence of the reference output and the target output.

14. The system of claim 13, wherein the operations further comprise:
applying a first weight to the first loss function to calculate a weighted first loss function; and
applying a second weight to the second loss function to calculate a weighted second loss function, wherein the combination of the first loss function and the second loss function comprises a sum of the weighted first loss function and the weighted second loss function, wherein the producing the optimized gradients comprises solving partial derivatives of the combination of the first loss function and the second loss function to determine the optimized gradients.

15. The system of claim 12, wherein the optimized gradients minimize an error of a combination of a first loss function and a second loss function, wherein the first loss function measures a divergence of the reference output and the target output, wherein the operations further comprise:
determining interim gradients that minimize an error of the first loss function; and
applying the interim gradients to weights in the target model to yield a temporary target model, wherein the second loss function measures a divergence of the target model and the temporary target model.

16. A method for editing a machine learning model to forget data, comprising:
inputting forget data samples of data samples to forget into a reference model, trained on a non-private data set, to produce reference output;
inputting the forget data samples to a target model, trained on a total data set comprising the non-private data set and a private data set to produce target output, wherein the private data set includes the forget data samples;
calculating a loss function to measure a divergence of the reference output and the target output; and
determining gradients that minimize an error of the loss function;
calculating optimized gradients from the determined gradients; and
applying the optimized gradients to update weights in the target model to produce an edited target model.

17. The method of claim 16, wherein the calculating the optimized gradients comprises:
inputting the gradients into an edit model to produce optimized gradients.

18. The method of claim 17, further comprising:
training the edit model to output the optimized gradients.

19. The method of claim 18, wherein the edit model is trained to minimize an error of a combination of a first loss function and a second loss function, wherein the first loss function measures a divergence of the reference output and the target output.

20. The method of claim 19, further comprising:
applying a first weight to the first loss function to calculate a weighted first loss function; and
applying a second weight to the second loss function to calculate a weighted second loss function, wherein the combination of the first loss function and the second loss function comprises a sum of the weighted first loss function and the weighted second loss function, wherein the producing the optimized gradients comprises solving partial derivatives of the combination of the first loss function and the second loss function to determine the optimized gradients.
